(19) United States
(12) Patent Application Publication
(10) Pub. No.: US 2008/0232561 A1
(43) Pub. Date: Sep. 25, 2008

(54) Advertising funded data access services

(75) Inventors: Robert Hildreth, Bellevue, WA (US); Darren R. Davis, Woodinville, WA (US); Myron C. Thomas, Newcastle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/725,725

(22) Filed: Mar. 20, 2007

(51) Int. Cl. H04M 1/64

(52) U.S. Cl. 379/88.22

(57) ABSTRACT

Techniques for using advertising to fund the use of client-side or network-side data access services by a user of a personal electronic device are discussed. Digital advertising content is associated with data items accessible via a particular data access service at a variety of processing locations, using a variety of techniques. An account having an account balance is used to record exchanges of consideration between the user and the data access service. When the user uses the personal electronic device to access data items via the data access service, the account balance is adjusted to reflect a consideration provided by the data access service. When the user consumes digital advertising content, the account balance is adjusted to reflect consideration provided by the user. In this manner, the account serves as a medium for the advertising source to fund the use of the data access service.

### BACKGROUND

As people amass digital content and the cost of electronic storage continues to decline, digital content is increasingly hosted and consumed on a variety of devices, such as servers, personal computers, hand-held computers, portable phones, personal digital assistants, in-vehicle devices, and home entertainment devices. Examples of digital content include but are not limited to personal or commercial digital media objects (such as video files, audio files, image files, graphics files, text files, multimedia files, data files, and playlists), documents, spreadsheets, and advertising content.

Personal electronic devices are generally equipped with connectivity features that allow communication over networks, and access to wide-area networks (“WANs”) and local-area networks (“LANs”) is virtually ubiquitous. A variety of client-side and network-side data access services enable people to access digital content almost anywhere they happen to be. Some commonly used data access services are broadcast media services, media downloading services, data synchronization services, email services, file sharing services, data storage services, data streaming services, messaging services, and document processing services (such as word processing applications or spreadsheet applications).

A user pays for data access services in various ways-by licensing software applications and/or purchasing specialized hardware, on a per-transaction basis, or via service subscriptions, for example.

Although advertising is a common source of revenue for providers of data access services that have a user audience (such as broadcast media services and interactive Internet-based services), users are not generally able to utilize advertising funding models to ubiquitously subsidize their use of other data access services.

It is desirable to provide techniques and platforms for using advertising to fund the use of many types data access services by users of personal electronic devices.

### SUMMARY

A user of a personal electronic device accesses a data item via the use of a client-side or network-side data access service. The use of the data access service is funded by the user's consumption of digital advertising content that originates from an advertising source. A client-side or network-side account serves as a medium for the advertising source to fund the use of the data access service by the user.

The account, which has an account balance, records exchanges of consideration between the user and the data access service. When the user uses the personal electronic device to access the data item via the data access service, the account balance is adjusted (debited or credited, depending on the nature of the account) to reflect a consideration provided by the data transfer service. When the user consumes the digital advertising content, the account balance is adjusted (debited or credited, depending on the nature of the account) to reflect a consideration provided by the user.

Digital advertising content is associated with the data item(s) accessible via the data access service at a variety of locations, using a variety of techniques. In one exemplary implementation, a source electronic device (which is a device that stores the accessed data item) associates digital advertising content with the data item. In another exemplary implementation, a target electronic device (which is a device to which the data item is transferred) associates digital advertising content with the data item. In a further exemplary implementation, a wide-area network-based service (which may be the data access service, an advertising service, or another service) associates the digital advertising content and the data item at any desired point during transfer of the data item from a source electronic device to a target electronic device. The personal electronic device operated by the user may be the source electronic device, the target electronic device, or a different device altogether. Advertising association criteria are used to identify specific digital advertising content for presentation to a user and/or to determine where, when or to whom digital advertising content is transmitted or presented.

The use of digital rights and identity management techniques in combination with the platforms and techniques described herein accommodates a wide variety of business models that simultaneously support the often diverse interests of individual users and different sources of digital content, such as online service providers, media content creators and distributors, advertising sources, and network operators.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a simplified functional block diagram of an architecture via which advertising is used to fund the use of a data access service by a user of a personal electronic device.

FIG. 2 is a simplified functional block diagram of the advertising-funded data access service platform shown in FIG. 1.

FIG. 3 is a flowchart illustrating certain aspects of a method for funding use of a data access service, aspects of which are performed by the platform shown in FIG. 2.

FIG. 4 is a simplified functional block diagram of an exemplary configuration of an operating environment in which the platform shown in FIG. 2 may be implemented or used.

### DETAILED DESCRIPTION

Techniques and platforms for using advertising to fund the use of a client-side or network-side data access service by a user of a personal electronic device are discussed. Digital advertising content is associated with a data item accessible via the data access service. Association of the digital advertising content with the data item may occur at various places and times, such as at a source electronic device, a target electronic device, or a wide-area network-based service. Advertising association criteria are used to identify specific digital advertising content for presentation to a user and/or to determine where, when or to whom digital advertising content is transmitted or presented. Generally, each advertisement available has a defined amount of associated consideration, which may be represented in any desired manner, such as by using points.

A client-side or network-side account having an account balance is used to record exchanges of consideration between the user and the data access service. When the user uses the personal electronic device to access the data item via the data access service, the account balance is adjusted (for example, points debited) to reflect a consideration provided by the data access service. When the user consumes digital advertising content, the account balance is adjusted by the associated amount (for example, points credited) to reflect consideration provided by the user. In this manner, the account serves as a medium for the advertising source to fund the use of the data access service by the user.

The use of digital rights and identity management techniques is also discussed in connection with the platforms and techniques described herein, as well as security techniques to guard against malicious presences such as hackers or malware.

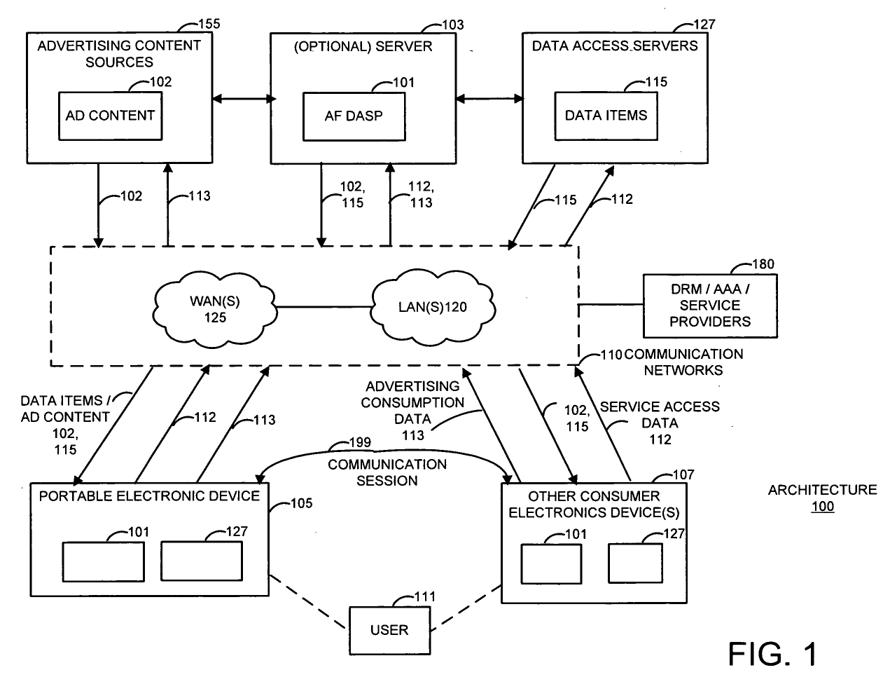

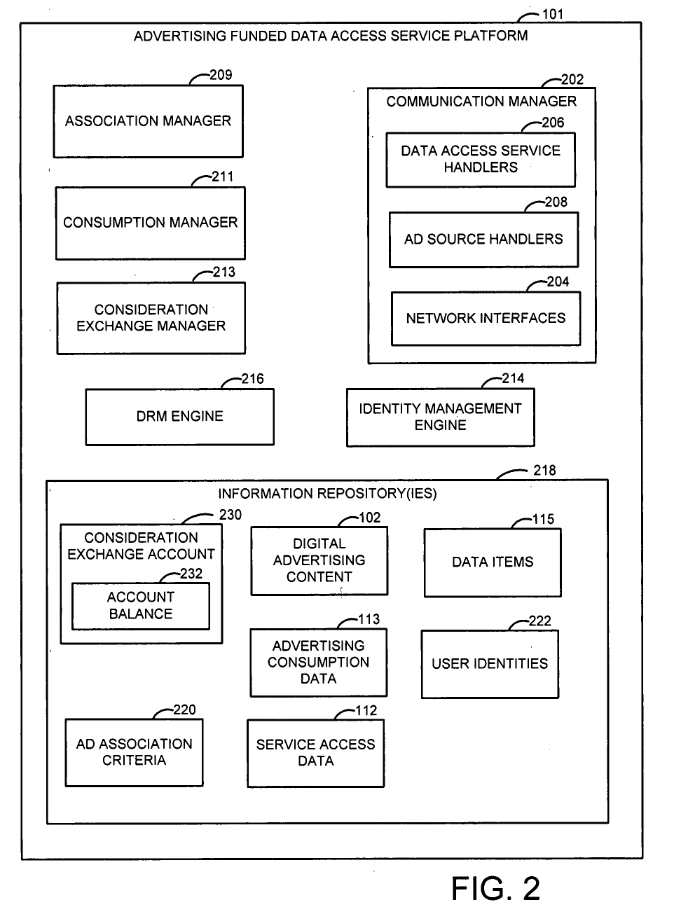

Turning to the drawings, where like numerals designate like components, FIG. 1 is a simplified functional block diagram of an architecture 100 that includes an advertising-funded data access service platform (“AF DASP”) 101 (discussed in connection with FIG. 2), aspects of which may be implemented within one or more networked servers 103 and/or within one or more personal electronic devices (devices 105, 107 are shown), each of which is configured for communication via one or more communication networks 110 and responsive to a user 111. AF DASP 101 facilitates the funding of the user's use of one or more client-side or network-side data access services 127 to access one or more data items 115. Such funding is achieved at least in part via the user's consumption of digital advertising content 102 that originates from advertising content sources 155. AF DASP 101 also handles aspects of the collection and (optional) distribution of advertising consumption data 113 and service access data 112 to various destinations within architecture 100 (advertising consumption data 113 and service access data 112 are discussed in connection with FIG. 2).

Advertising content sources 155 represent any sources of digital advertising content 102. Digital advertising content 102 represents digital advertisements and metadata associated with digital advertisements. Digital advertisements are generally digital media items such as audio files, video files, text files, image files, or multimedia files. Metatdata associated with digital advertisements is any information, in any form or format, about the digital advertisements or information regarding the association(s) of digital advertisements with data items 115 (for example, metadata describing data items 115 and their movements throughout architecture 100 via use of data access services 127). Examples of metadata associated with digital advertisements include but are not limited to advertising source information, expiration data information, hyperlinks to Web sites, presentation schedule information, advertising duration, file size information, and format information. Digital advertisements generally have consideration values associated with them, which may be represented logically in any desired manner, such as by using points. A consideration value may be a fixed amount assigned to all (or subsets of) digital advertisements referred to by AF DASP 101 or may be specific to a particular digital advertisement. As with traditional media and print advertising, numerous methods both known and yet known for determining the particular consideration value of a digital advertisement are possible.

Data items 115 represent any commercial or non-commercial digital content accessible via one or more data access services 127. Examples of data items 115 include but are not limited to: digital media items, such as audio files, video files, text files, image files, multimedia files, playlists, and metadata relating to digital media items; documents; spreadsheets; consumer transaction data; digital payment or licensing instruments; and data such as profiles, contacts lists, and the like. Data items 115 may exist in any known or later developed format or combination thereof. Data items 115 may be protected by one or more enforceable intellectual property rights of one or more third parties, such as copyrights, patent rights, trademark rights, or trade secret rights.

Data access services 127 represent any client-side or network-side services that allow user 111 to access one or more data items 115. Examples of data access services 127 include but are not limited to: broadcast media reception services; media rendering services; media downloading services; data synchronization services; email services; file sharing services; data storage services; data streaming services; messaging services; or document processing services (such as word processing applications or spreadsheet applications).

Portable electronic device 105 and consumer electronics device(s) 107 are examples of personal electronic devices. A personal electronic device is any electronic device (or any physical or logical element of such an electronic device, either standing alone or included in other devices), which is configured for communication via one or more communication networks 110 and which is responsive to a user. Portable electronic device 105 and consumer electronics device(s) 107 may be configured to render digital advertising content 102, or alternatively to pass digital advertising content 102 to other devices configured to render digital advertising content 102. Examples of portable electronic devices 105 include but are not limited to mobile phones, personal digital assistants, laptops, personal media players, image or video capture/playback devices, or devices temporarily or permanently mounted in transportation equipment such as planes, trains, or wheeled vehicles. Examples of consumer electronics device(s) 107 include but are not limited to set-top boxes, game consoles, stereos, digital video recorders/players, PCs, televisions, cable modems, local gateways, or hard drive storage devices.

Server 103 represents one or more processing locations within or accessible by communication networks 110, which optionally host aspects of AF DASP 101.

Collectively, communication networks 110 represent any existing or future, public or private, wired or wireless, wide-area (“WANs” 125) or local-area (“LANs” 120), packet-switched or circuit-switched, one-way or two-way digital data transmission infrastructures or technologies. Exemplary networks 110 include: the Internet; managed WANs (for example, cellular networks, satellite networks, fiber-optic networks, co-axial cable networks, hybrid networks, copper wire networks, and over-the-air broadcasting networks such as television, radio, and datacasting networks); local area networks (for example, wireless local area networks and personal area networks, or direct cable connections); and temporary networks created through the use of near field communication (NFC) devices.

Communication session 199 represents any direct or proxied inter-device communication that may occur via a particular communication network 110 (which may be different from the communication network(s) 110 described above) in connection with the operation of a particular data access service 127 and/or AF DASP 101. Communication sessions 199 facilitate the transfer of data items 115 and/or digital advertising content 102 to, from, or between personal electronic devices via copying, downloading, uploading, synchronizing, or other known or developed transport techniques. Communication sessions 199 may be established between a particular personal electronic device and a network-side service, between two personal electronic devices, or between two network-side services. Portions of the communication can also be facilitated by the exchange of data using SMS-based text messaging services and data access service(s) 127.

DRM/AAA service providers 180 represent any network-side implementations of digital rights management (“DRM”) systems or techniques or authentication, authorization, and accounting (“AAA”) systems or techniques. DRM/AAA services 180 are generally used in combination with aspects of the advertising-funded data access transactions facilitated by AF DASP 101.

FIG. 2 is a simplified functional block diagram of AF DASP 101 shown in FIG. 1, aspects of which may be implemented within a personal electronic device such as portable electronic device 105 or consumer electronics device(s) 107, and optionally within networked server 103. AF DASP 101 facilitates the funding of user 111's use of one or more client-side or network-side data access services 127 to access one or more data items 115, via user 111's consumption of digital advertising content 102 that originates from advertising content sources 155. AF DASP 101 also handles aspects of the collection and (optional) distribution of advertising consumption data 113 and service access data 112 to various destinations within architecture 100.

In general, design choices and/or operating environments (for example, a network-side environment or a client-side environment) dictate how and whether specific functions of AF DASP 101 are implemented. Such functions may be implemented using hardware, software, firmware, or combinations thereof. Particular configurations of AF DASP 101 may include fewer, more, or different components than those described. It will further be understood that computer programs that facilitate advertising-funded data access transactions may operate at any layer of a communication protocol stack, such as at any layer of the well-known stack that defines internetworking: layer 1, the Physical Layer; layer 2, the Data Link Layer; layer 3, the Network Layer; layer 4, the Transport Layer; layer 5, the Session Layer; layer 6, the Presentation Layer; and layer 7, the Application Layer.

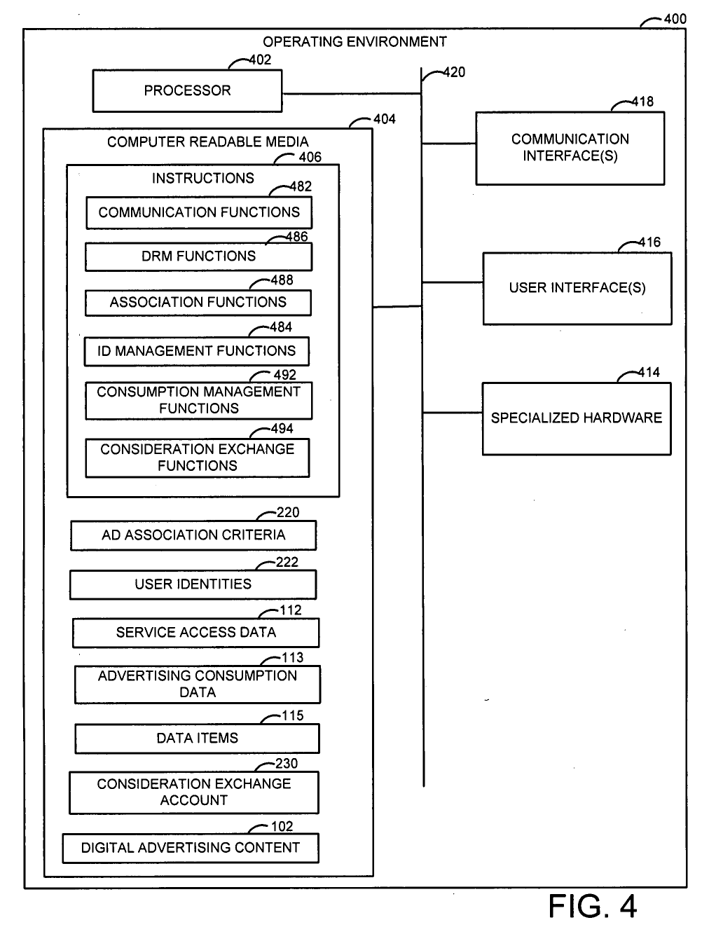

As shown, AF DASP 101 includes: communication manager 202, which further includes network interfaces 204, data access service handlers 206, and advertising content handlers 208; association manager 209; consumption manager 211; consideration exchange manager 213; DRM engine 216; identity management engine 214; and one or more information repositories 218, which store data items 115, digital advertising content 102, advertising association criteria 220, user identities 222, consideration exchange account 230 (discussed in connection with consideration exchange manager 213) having account balance 232, advertising consumption data 113 (discussed in connection with consumption manager 211), and service access data 112 (also discussed in connection with consumption manager 211). Information repositories 218 may be implemented using various types and arrangements of computer-readable media 404 (discussed further below, in connection with FIG. 4). AF DASP 101 may include a security session manager component (not shown), which secures access to items (such as the consideration exchange account) and/or the ways in which data is communicated via AF DASP 101 against malicious presences such as hackers or malware.

Referring first to certain information stored within information repositories 218, advertising association criteria 220 include information usable for decision-making regarding: what, when and how digital advertising content 102 is obtained from advertising content sources 155; what, when, and how digital advertising content 102 is transmitted to a particular personal electronic device 105, 107; and what, when, and how digital advertising content 102 is presentable to user 111. Generally, advertising association criteria 220 enhance targeting of digital advertisements to individuals or groups. Advertising association criteria 220 may be received from advertising content sources 155, pre-programmed into or generated by a particular server or device, or received from third parties (such as data access service providers or other third parties). In one scenario, advertising association criteria 220 take the form of metadata transmitted with, or separate from, digital advertising content 102. Advertising association criteria 220 may be predetermined, or may be modified based on operation of AF DASP 101. It will be appreciated that virtually unlimited advertising association criteria 220 and combinations thereof are definable.

Examples of advertising association criteria 220 include but are not limited to: information about user 111 (such as user profiles, user preferences, user identities 222, information collected based on previous activities of the user with respect to AF DASP 101 or other services, and electronic affiliations of the user with other people or services as determined by user communities, buddy lists or service subscriptions); business rules (such as rules specifying conditions under which particular digital advertisements are available from advertising content sources 155, bundling or presentation rules reflecting advertisers' preferences/restrictions, rules specifying conditions under which particular digital advertisements expire, instructions for obtaining available digital advertisements (such as whether the digital advertisements are pushed to AF DASP 101 or pulled by AF DASP 101 from locations provided by advertising content sources 155), and rules governing requests to advertising content sources 155 for digital advertisements meeting certain criteria); temporal references (such as times, dates, or time zone data); information related to data items 115; characteristics of personal electronic devices 105, 107 (such as identification numbers, device types, destination addresses, processing capabilities, network connectivity capabilities, and memory capabilities); and characteristics of communication networks 110 (such as network access protocols, network latency, network availability, network bandwidth, network usage level, network reliability, and network usage cost). To address privacy concerns, users may have control over whether and/or which information is collected and included in user profiles, and may also have control over how or by whom such information is used or accessed.

User identities 222 represent the pieces of information about user 111 and/or personal electronic devices 105, 107 that an issuer (user 111 or another entity) asserts are valid. Collectively, these pieces of information are referred to as “claims”. Identity management engine 214 (discussed further below) is responsible for the management of user identities 222.

Referring again to components of AF DASP 101, communication manager 202 includes one or more physical or logical elements, such as connectivity devices or computer-executable instructions, which enable intra- or inter-device communication. For example, communication manager 202 may facilitate communication between a WAN-based AF DASP 101 (or another WAN-based service) and a client-side AF DASP 101, between two client-side AF DASPs 101, or between a WAN-based AF DASP 101 and another WAN-based service.

Network interfaces 204 are responsible for the receipt and processing of data by a particular device as such data traverses layers of communication protocols, such as communication protocols associated with any known or later developed communication model. An exemplary communication model is the well-known abstract model that defines internetworking: layer 1, the Physical Layer; layer 2, the Data Link Layer; layer 3, the Network Layer; layer 4, the Transport Layer; layer 5, the Session Layer; layer 6, the Presentation Layer; and layer 7, the Application Layer. As such, network interfaces 204 may include data interfaces, operations support interfaces, radio frequency interfaces, and the like (implemented, for example, by routers, switches, modems, or other network connection support devices or software).

Data access service handlers 206 define the way in which a particular implementation of AF DASP 101 communicates with a particular data access service 127 for the purpose of exchanging information about data access transactions conducted using that particular data access service. In one possible implementation, multiple, pluggable data access service adapters are defined. In an alternative implementation, a specific adapter is defined that is generally supported by all data access services 127. Communication may be initiated by AF DASP 101 or a specific data access service, and data push or pull techniques may be employed.

Advertising source handlers 208 define the way in which AF DASP 101 communicates with one or more advertising content sources 155. Such communication may be initiated by AF DASP 101 or a particular advertising content source, and data push or pull techniques may be employed. In one scenario, a network-side advertising source handler 208 is responsible for obtaining certain digital advertising content 102 from advertising content sources 155 and arranging for transfer of the digital advertising content to personal electronic devices 105, 107. In other scenarios, network-side and/or client-side advertising source handlers 208 may facilitate the transfer of certain advertising content 102 directly from advertising content sources 155 to personal electronic devices 105, 107. Advertising association criteria 220 may be used in connection with the functions of advertising source handlers 208. It will be appreciated that advertising content sources 155 may use various formats, communication protocols or techniques to provide encoding and/or transport for digital advertising content 102 via communication networks 110.

Association manager 209 is responsible for identifying digital advertising content 102 for presentation to user 111 and optionally for arranging for transmission of the digital advertising content to a particular personal electronic device 105, 107. Digital advertising content 102 may be transmitted to personal electronic devices 105, 107 either separately from data items 115 that are the subject of particular data access transactions performed via data access services 127, or together with such data items 115. When received separately from data items 115, digital advertising content 102 may be cached and concatenated on personal electronic devices 105, 107 in a variety of ways (based on advertising association criteria 220, for example). Both data access transactions and the transmission of digital advertising content to a particular personal electronic device may be accomplished/conducted via communication networks 110 using a variety of protocols or techniques. Examples of some higher-level protocols or techniques include but are not limited to: Internet protocols; mobile data transmission protocols; cable transmission protocols; over-the-air broadcasting protocols; and satellite transmission protocols.

Optionally, specific digital advertising content 102 is associated with specific data items 115 that are the subject of data access transactions performed via data access services 127. In one exemplary implementation, association manager 209 is configured to observe the flow of data items 115 accessed via data access services 127, identify characteristics of the accessed data items (such as type, size, source, destination, and the like), and dynamically associate metadata tags and/or digital advertisements with the data items as they are accessed. In this manner, digital advertising content 102 may be associated with accessed data items 115, or specific data items 115 may be tagged with digital advertising content 102, at a variety of locations within architecture 100. In one scenario, AF DASPs 101 within personal electronic devices serving as sources (or targets/recipients) of data items 115 accessed via certain data access services 127 may associate digital advertisements within the accessed data items, or tag the accessed data items with metadata relating to digital advertisements. In another scenario, network-side services such as a WAN-based AF DASP 101, advertising content sources 155, or data access services 127 may associate digital advertisements within the accessed data items 115 or tag the accessed data items with metadata. Association of digital advertisements with specific data items 115 may be done by a variety of techniques both known and not yet known. In some cases association manager 209 may maintain links between digital advertising content 102 and a specific data item 115 by use of an external database. In alternate embodiments, association manager may update metadata associated with data items 115 with information about an associated piece of digital advertising content. Digital advertising content 102 may also be embedded in data items 115 (for example, watermarking a photo).

Consumption manager 211 is responsible for handling advertising consumption data 113 and service access data 112.

Advertising consumption data 113 is obtained by monitoring consumption by user 111 of digital advertising content 102. Generally, advertising association criteria 220 (such as playback rules) specify when and how certain digital advertising content 102 is presented by personal electronic devices 105, 107 to user 111. Certain digital advertising content may be consumed passively (displayed in the background of a user display, for example), while other digital advertising content may be consumed actively (such as via user click-throughs). In the operating environment of personal electronic devices 105, 107, consumption manager 211 responds to requests from user interface elements or applications running on personal electronic devices 105, 107 to provide advertising of a form usable by the requesting component. Once the advertising has been presented, the component notifies consumption manager 211 in a secure manner that the advertising has been presented and consumption manager 211 records information about when the digital advertisements are presented to user 111, along with information obtained via the interaction (if any) of user 111 with the particular digital advertisements. Advertising consumption data 113 is optionally transmitted to a network-side service (such as AF DASP 101 within networked server 103, advertising content sources 155, data access services 127, or other third party services), where it can be used for various purposes, such as enhancing targeting of advertisements to individuals or groups, market research, forming business affiliations, or for other purposes.

Service access data 112 is obtained by monitoring consumption by user 111 of data access services 127. Consumption manager 211 may use any of a number of methods now known or not yet known to determine how user 111 has consumed data from data access services 127. In some cases consumption manager 211 may be configured to simply monitor the amount of information (for example, a count of bytes or another type of measurement) exchanged using data access service 127. Alternatively, consumption manager 211 may be notified by data access service handlers 206 of the amount of data consumed. In the operating environment of personal electronic devices 105, 107, consumption manager 211 records information (such as information from data access service handlers 206) regarding certain aspects of data access transactions. Service access data 112 is optionally transmitted to a network-side service (such as AF DASP 101 within networked server 103, advertising content sources 155, data access services 127, or other third party services).

Consideration exchange manager 213 receives advertising consumption data 113 and service access data 112, and based thereon records exchanges of consideration between user 111 and a provider of a particular data access service 127 in consideration exchange account 230. It will be appreciated that one or more consideration exchange accounts 230 may be used, depending on the number of participating users and data access services. It will be appreciated that consideration exchange account 230 may located in a variety of places, including but not limited to networked server 103 (although a host server is not required to get the benefit of account 230) and personal electronic devices 105, 107, that different data access services may utilize the same account 230, and that various accounts/information may be reconciled in flexible manners. Exchange account 230 represents a high-value asset, and it is desirable to protect exchange account 230 against malicious presences such as hackers or malware using any of a number of now known or not yet known security techniques.

Consideration is something of value given by one party to another in exchange for an act or promise. In the context of using digital advertising content 102 to fund use of a particular data access service 127 by user 111, consideration given by user 111 is advertising consumption (or the promise to consume advertising), which can be expressed in terms of advertising consumption data 113, and consideration given by the service provider is use of the data access service (or the promise to provide the data access service), which can be expressed in terms of service access data 112. For example, advertising consumption data 113 and service access data 112 may be translated into units of consideration in accordance with any desired scheme or algorithm. Generally, account balance 232 of consideration exchange account 230 is adjusted (debited or credited, depending on the nature of account 230 and/or the applicable party) based on units of consideration associated with both advertising consumption data 113 and service access data 112. Specific amounts of various adjustments are matters of implementation preference and/or negotiation between the parties using AF DASP 101. In this manner, consideration account 230 serves as a medium for advertising content sources 155 to fund the use of data access services 127 by user 111. It will be appreciated, however, that consideration may take other forms (such as payments of money or promises to pay money, or the providing or redeeming of redeemable articles, discounts, services and the like).

Referring again to AF DASP 101 shown in FIG. 2, DRM engine 216 represents any digital rights management system or technique operable to enable acquisition of digital licenses covering aspects of the operation of AF DASP 101.

Identity management engine 214 is responsible for establishing a level of trust between devices. There are numerous well-known techniques available for establishing trust between devices through authentication and authorization schemes. Authentication is the process of identifying a user. Authorization is the process of enforcing policies relating to what types or qualities of activities, resources, or services the user is permitted to access. In some cases, authentication may encompass the authorization process. In general, identity management engine 214 provides for: representing user identities 222; conducting communications between identity providers, relying parties, and identity subjects; and using appropriate protocol(s) for handling claims. In one exemplary implementation, AF DASP 101 facilitates selection of a particular identity associated with user 111 to achieve varying amounts of access to features of AF DASP 101, digital advertising content 102, data items 115, and/or data access services 127. Identities may be selected manually or automatically.

With continuing reference to FIGS. 1 and 2, FIG. 3 is a flowchart illustrating certain aspects of a method for using advertising, such as digital advertising content 102, to fund the use of a data access service, such as a particular data access service 127. Aspects of the method are usable with personal electronic devices and/or one or more networked servers within communication architecture 100. The method may be implemented using computer-executable instructions executed by one or more general, multi-purpose, or single-purpose processors (exemplary computer-executable instructions 406 and processor 402 are discussed further below, in connection with FIG. 4). Certain method steps may be performed by client-side acts, network-side acts, or both. Unless specifically stated, the method described herein is not constrained to a particular order or sequence, the method or elements thereof can occur or be performed concurrently, and all of the described steps need not occur.

For exemplary purposes, one data access transaction is discussed, in which user 111 of portable electronic device (“PED”) 105 uses a data synchronization service 127 to synchronize a data item 115 located on a consumer electronic device 107 (referred to as a PC) to portable electronic device 105. The data synchronization service is configured for operation on both PED 105 and PC 107, and aspects thereof may also be implemented as an Internet service. It is assumed that both portable electronic device 105 and PC 107 possess IP addresses usable for direct or proxied communication (with each other and other devices or services) via the Internet, and that port numbers have been assigned to their respective data synchronization services and AF DASPs 101.

Prior to the discussion of the flowchart, it is noted that with respect to any type of data access transaction having multiple participants, but with respect to the exemplary data access transaction in particular, it may be desirable to establish a level of trust between the participants in such transactions (initially, and at any other desired points throughout the transactions). Such trust may be established using any now known or later developed authentication, authorization, or accounting (“AAA”) activities. In the context of the exemplary transaction, user 111 may present a particular user identity 222 (selected from among a number of possible identities via a user interface provided by PED 105) to PC 107 and/or an appropriate network-side service, and upon verification of the particular user identity, various levels of access to data items 115/data access services 127 may be granted. One or more claims, which may be self-issued and/or verifiable via AAA/DRM servers 180, are generally made regarding items of information associated with each user identity 222 (together items of information and claims are referred to as “credentials”).

Turning now to the flowchart, the method begins at block 300 and continues at block 302, where user 111 of PED 105, the desired data access service (the data synchronization service), and the data item to be accessed, are identified.

It is assumed that user 111, PED 105, PC 107, and data item 115 have been identified, and that any desired AAA activity has been successfully performed. A direct or proxied communication session 199 has also been established between PED 105 and PC 107 for the purpose of transporting the selected data item 115 from PC 107 to PED 105 (communication session 199 may be established using any desirable now known or later developed protocol or technique).

At block 304, digital advertising content 102 is identified and/or associated with the data access transaction. In general, association manager 209 is responsible for using advertising association criteria 220 to identify digital advertising content 102 for presentation to user 111 via PED 105. For example, playback rules may specify when certain digital advertising content is playable by PED 105. Digital advertising content 102 may be obtained automatically, requested, or a combination thereof (for example, digital advertising content 102 may be automatically or manually pushed by or pulled from a network-side service, and special requests may be made for various reasons, such as upon expiration of advertisements or errors in receipt). Digital advertising content 102 may or may not be associated specifically with data item 115 that is being synchronized between PC 107 and PED 105. In one scenario, which may occur whether or not digital advertising content 102 is specifically associated with synchronized data item 115, digital advertising content 102 is transmitted separately from data item 115. For example, applicable digital advertising content 102 may have been previously transmitted to PED 105, and cached and concatenated on PED 105 based on advertising association criteria 220, or may be transmitted to PED 105 on-the-fly.

If specific digital advertising content 102 is to be associated with synchronized data item 115, such association can be performed at a variety of locations within architecture 100. For example, communication session 199 may be monitored, and metadata tags and/or digital advertisements may be dynamically associated with synchronized data item 115, by PC 107, a network-side service (such as WAN-based AF DASP 101, advertising content sources 155, or the synchronization service), or PED 105. In this manner, digital advertising content 102 may be associated with accessed data items 115, or specific data items 115 may be tagged with associations to digital advertising content 102.

Next, as indicated at blocks 306, 308, and 310, an account, such as consideration exchange account 230 having account balance 232, is accessed, and the account balance is adjusted when data item 115 is accessed and when user 111 consumes digital advertising content 102.

Generally, consumption manager 111 is responsible for generating advertising consumption data 113 upon consumption by user 111 of digital advertising content 102. Advertising presentation systems and techniques are not discussed in detail herein, although it will be appreciated that certain digital advertising content may be consumed passively (displayed in the background of a user display, for example), while other digital advertising content may be consumed actively (such as via user click-throughs). In order to provide advertising content, a presentation service communicates with consumption manager 211 to request advertising appropriate to its presentation model. For example, the background theme component of PED 105 may request an advertising image from consumption manager 211 when the screen of PED 105 is turned on. Once the presentation service has completed showing the advertisement, advertising consumption manager 211 is notified in a secure fashion and advertising consumption data 113 is updated. Advertising consumption manager 211 is also responsible for generating service access data 112 by monitoring consumption by user 111 of data access services 127. In the exemplary data access transaction, certain aspects of the synchronization transaction (such as receipt of data item by PED 105) may be monitored (at one or more devices) by a data access service handler 206 associated with the synchronization service, and trigger the creation of service access data 112.

It will be appreciated that certain DRM activities (such as granting or obtaining appropriate digital licenses) may be performed before or after data items protected by enforceable intellectual property rights are selected and/or accessed via relevant data access services. In one scenario, DRM technologies may be used to restrict access to certain data items 115 until certain digital advertising content 102 is consumed by user 111.

Consideration exchange manager 213 is responsible for adjusting (debiting or crediting) balance 232 of consideration exchange account 230 based on advertising consumption data 113 and service access data 112. It will be appreciated that consideration exchange account 230 may located in a variety of places, including but not limited to networked server 103 (although a host server is not required to get the benefit of account 230) and personal electronic devices 105, 107. It will also be appreciated that consideration exchange account 230 may be reconciled in a variety of ways and times (for example, in real-time, cached mode, batch mode, or using another periodic scheduling technique), and that other forms of consideration from user 111 and/or data access service providers may result in the adjustment of account balance 232. It is appreciated that AF DASP 101 may be required to take additional action in order to reconcile consideration exchange account 230 beyond simply debiting and crediting of the account. For example it may restrict access to data access service 127 until the amount of consideration received by viewing advertisements is equal to the amount of consideration required by receiving data items 115 via data access service 127.

In this manner, consideration account 230 serves as a medium for advertising content sources 155 to fund the use of data access services 127 by user 111. AF DASP 101 and the techniques described herein are usable by, and commercially beneficial to, advertisers, content/data access service providers, network operators, and users of personal electronic devices. Users can receive digital advertising content from a variety of providers and/or network operators, and can spend their advertising dollars in a flexible manner. Data access services may achieve more widespread use and realize additional revenue. Information regarding users' consumption of digital advertising content is readily collected and used. Advertising techniques such as the utilization of interactive advertising, mixed formats and alternate media types, and the insertion of up-to-date advertising are made possible.

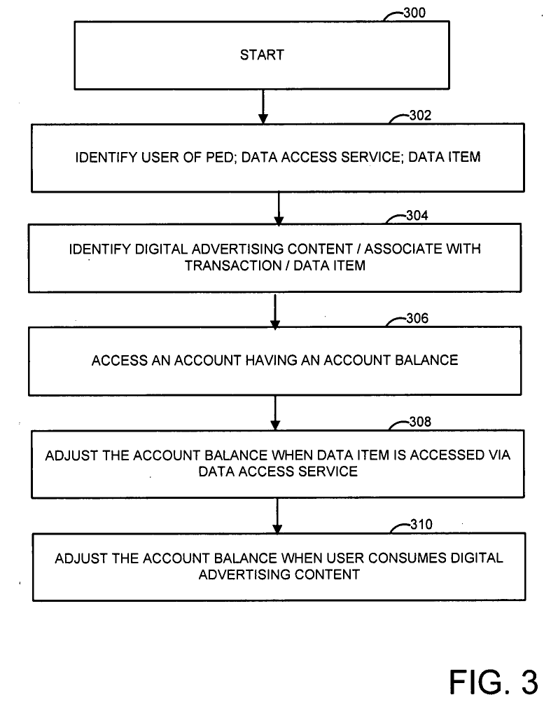

With continued reference to FIGS. 1-3, FIG. 4 is a block diagram of an exemplary configuration of an operating environment 400 in which all or part of AF DASP 101 and/or the methods shown and discussed in connection with FIG. 3 may be implemented or used. Operating environment 400 is generally indicative of a wide variety of general-purpose or special-purpose computing environments, and is not intended to suggest any limitation as to the scope of use or functionality of the system(s) and methods described herein. For example, operating environment 400 may be a personal electronic device 105, 107. Operating environment 400 may also be a network-side operating environment, such as a server.

As shown, operating environment 400 includes processor 402, computer-readable media 404, and computer-executable instructions 406. One or more internal buses 420, which are widely available elements, may be used to carry data, addresses, control signals and other information within, to, or from operating environment 400 or elements thereof.

Processor 402, which may be a real or a virtual processor, controls functions of operating environment 400 by executing computer-executable instructions 406. Processor 402 may execute instructions 406 at the assembly, compiled, or machine-level to perform a particular process.

Computer-readable media 404 represent any number and combination of local or remote devices, in any form, now known or later developed, capable of recording, storing, or transmitting computer-readable data, such as computer-executable instructions 406, advertising association criteria 220, user identities 222, service access data 112, advertising consumption data 113, data items 115, digital advertising content 102, and consideration exchange account 230. In particular, computer-readable media 404 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. Computer-readable media 404 may also include transmission media and data associated therewith. Examples of transmission media/data include, but are not limited to, data embodied in any form of wireline or wireless transmission, such as packetized or non-packetized data carried by a modulated carrier signal.

Computer-executable instructions 406 represent any signal processing methods or stored instructions. Generally, computer-executable instructions 406 are implemented as software components according to well-known practices for component-based software development, and encoded in computer-readable media (such as computer-readable media 404). Computer programs may be combined or distributed in various ways. Computer-executable instructions 406, however, are not limited to implementation by any specific embodiments of computer programs, and in other instances may be implemented by, or executed in, hardware, software, firmware, or any combination thereof.

As shown, certain computer-executable instructions 406 implement communication functions 482, which implement aspects of communication manager 202; certain computer-executable instructions 406 implement DRM functions 486, which implement aspects of DRM Engine 216; certain computer-executable instructions 406 ID management functions 484, which implement aspects of identity management engine 214; certain computer-executable instructions 406 implement association functions 488, which implement aspects of association manager 209; certain computer-executable instructions 406 implement consumption management functions 492, which implement aspects of consumption manager 211; and certain computer-executable instructions 406 implement consideration exchange functions 494, which implement aspects of consideration exchange manager 213.

User interfaces 416 are physical or logical elements that define the way a user interacts with a particular application or device. Generally, presentation tools are used to receive input from, or provide output to, a user. An example of a physical presentation tool is a display such as a monitor device. An example of a logical presentation tool is a data organization technique (such as a window, a menu, or a layout thereof). Controls facilitate the receipt of input from a user. An example of a physical control is an input device such as a remote control, a display, a mouse, a pen, a stylus, a microphone, a keyboard, a trackball, or a scanning device. An example of a logical control is a data organization technique via which a user may issue commands. It will be appreciated that the same physical device or logical construct may function as an interface for both inputs to, and outputs from, a user.

Communication interface(s) 418 are one or more physical or logical elements such as connectivity devices or computer-executable instructions that enable communication by operating environment 400 via one or more protocols or techniques, at one or more layers of the Internetworking Model.

Specialized hardware 414 represents any hardware or firmware that implements functions of operating environment 400. Examples of specialized hardware 430 include encoder/decoders (“CODECs”), application-specific integrated circuits, and the like.

It will be appreciated that particular configurations of operating environment 400 or AF DASP 101 may include fewer, more, or different components or functions than those described. In addition, functional components of operating environment 400 or AF DASP 101 may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A method for funding use of a data access service, the method comprising:
identifying a user of a personal electronic device;
identifying a data access service that is accessible via the personal electronic device;
identifying a data item that is accessible via the data access service;
identifying digital advertising content for consumption by the user, the digital advertising content originating from an advertising source;
associating the digital advertising content with the data item;
accessing an account for recording exchanges of consideration between the user and the data access service, the account having an account balance;
when the user uses the personal electronic device to access the data item via the data access service, adjusting the account balance to reflect a consideration provided by the data access service; and
when the user consumes the digital advertising content, adjusting the account balance to reflect a consideration provided by the user,
the account serving as a medium for the advertising source to fund the use of the data access service by the user.

2. The computer-readable medium according to claim 1, wherein the step of identifying a user comprises
ascertaining an identity associated with the user; and
basing one or more of the steps of
identifying a data access service,
identifying a data item,
identifying digital advertising content,
associating the digital advertising content with the data item, and
accessing an account
on the ascertained identity.

3. The method according to claim 1, wherein the step of identifying a data item comprises
identifying the data item based on input from the user received via the personal electronic device.

4. The method according to claim 1, wherein the data item is protected by a predetermined intellectual property right, and wherein prior to the user using the personal electronic device to access the data item via the data access service, the method comprises
arranging for granting, via a digital rights management technique, a right to the user under the predetermined intellectual property right,
the granted right conditioned upon the user's consumption of the digital advertising content.

5. The method according to claim 1, wherein the data item is stored on the personal electronic device.

6. The method according to claim 1, wherein the data item is stored in a catalog of available data items, the catalog provided by a WAN-based service.

7. The method according to claim 1, wherein the data transfer service comprises a client-side application or a network-side application, and wherein the account is located on a networked server or a client-side device.

8. The method according to claim 1, wherein the data transfer service comprises an application.

9. The method according to claim 1, wherein the step of identifying digital advertising content comprises
based on a predetermined rule, selecting a digital advertisement, and
associating the selected digital advertisement with the user.

10. The method according to claim 1, wherein the step of associating the digital advertising content with the data item is selected from the group consisting of:
tagging the data item with digital advertising content; and
embedding the digital advertising content within the data item.

11. The method according to claim 10, wherein the step of associating digital advertising content with the data item is performed in a manner selected from the group consisting of:
the step of associating being performed by the personal electronic device, prior to the user using the personal electronic device to access the data item;
the step of associating being performed by the personal electronic device, after the user uses the personal electronic device to access the data item;
the step of associating being performed by a WAN-based service, prior to the user using the personal electronic device to access the data item;
the step of associating being performed by a WAN-based service, after the user uses the personal electronic device to access the data item;
the step of associating being performed by a WAN-based service, as the data item is transferred between a source electronic device and a target electronic device.

12. The method according to claim 11, wherein the WAN-based service is selected from the group consisting of: a service provided on behalf of the advertising source; a service provided on behalf of the data transfer service; and a third party service.

13. The method according to claim 1, wherein the step of adjusting the account balance to reflect a consideration provided by the data transfer service comprises crediting the account balance.

14. The method according to claim 1, wherein the step of adjusting the account balance to reflect a consideration provided by the user comprises debiting the account balance.

15. The method according to claim 1, further comprising:
generating service access data when the data item is accessed via the data access service;
generating advertising consumption data when the digital advertising content is presented to the user;
transmitting the service access data and the advertising consumption data to a data collection service,
the consideration provided by the data transfer service based on the service access data, and the consideration provided by the user based on the consumption data.

16. The method according to claim 15, further comprising:
arranging for active or passive presentation of the digital advertising content to the user via personal electronic device.

17. An apparatus, comprising:
a computer-readable storage medium; and
a processor responsive to the computer-readable storage medium and to computer-executable instructions stored on the computer-readable medium, the computer-executable instructions executable by the processor to
identify a user of a personal electronic device,
identify a data access service that is accessible via the personal electronic device,
identify a data item that is accessible via the data access service,
identify digital advertising content for consumption by the user, the digital advertising content originating from an advertising source,
associate the digital advertising content with the data item,
access an account for recording exchanges of consideration between the user and the data access service, the account having an account balance,
when the user uses the personal electronic device to access the data item via the data access service, adjust the account balance to reflect a consideration provided by the data access service, and
when the user consumes the digital advertising content, adjust the account balance to reflect a consideration provided by the user,
the account serving as a medium for the advertising source to fund the use of the data access service by the user.

18. The apparatus according to claim 17, wherein the apparatus comprises a personal electronic device.

19. The apparatus according to claim 17, wherein the apparatus comprises a networked server.

20. A system, comprising:
a communication manager configured to identify when a user of a personal electronic device accesses a data item via a data access service;
an association manager responsive to the communication manager, the association manager configured to associate the data item with digital advertising content originating from an advertising source;
a consumption manager configured to
generate advertisement consumption data when the digital advertising content is presented to the user, and
generate service access data when the user of the personal electronic device accesses the data item via the data access service; and
a consideration exchange manager responsive to the consumption manager, the consideration exchange manager configured to maintain an account having an account balance, the account balance adjusted based on the consumption data and the service access data,
the account serving as a medium for the advertising source to fund the use of the data access service by the user.
